(19) United States
(12) Patent Application Publication
(10) Pub. No.: US 2009/0027797 A1
(43) Pub. Date: Jan. 29, 2009

(54) Data Storage And Manipulation

(76) Inventors: Charles Frederick Barnes, East Sussex (GB); Gary Brian Jones, East Sussex (GB)

Correspondence Address: SUGHRUE MION, PLLC, 2100 PENNSYLVANIA AVENUE, N.W., SUITE 800, WASHINGTON, DC, 20037, US

(21) Appl. No.: 12/088,211

(22) PCT Filed: Sep. 26, 2006
(86) PCT No.: PCT/GB2006/003564

§ 371 Date: Aug. 27, 2008

(30) Foreign Application Priority Data
Sep. 26, 2005 (GB) 0519595.3

(51) Int. Cl. G11B 5/02

(52) U.S. Cl. 360/55; G9B/5.026

(57) ABSTRACT

A data storage device comprises: a data member comprising means for storing data on a surface thereof; and a data retrieval member. The data retrieval member comprises: a plurality of heads for reading data from the data member; and a plurality of storage buffers each arranged to store data read from one of more of said heads. The retrieval member is arranged so as to output the contents of a plurality of said storage buffers sequentially. This allows fast and efficient reading of the data stored.

Also disclosed is a telecommunications switch which may employ such a storage device. The switch dynamically assigns data packets to nodes as an output path becomes available to minimise queuing delays.

This invention relates to devices and methods for storing and manipulating data. In particular it relates to developments of the technology described in WO 2004/038701 the contents of which is herein incorporated by reference.

WO 2004/038701 describes data storage arrangements which represent a complete shift away from development of the traditional hard disk model with an ever more rapidly rotating disk to reduce data access times. One of the key themes in WO 2004/038701 is that of a large array of data reading heads co-operating with a data storage member which allows very rapid access to data without requiring fast rotational speeds.

This design model has already been shown capable of ending the position of the mass data storage medium as the limiting factor on computer performance even with relatively conservative implementations. However as the applications of this technology are developed and the implementations optimised, very much higher data rates have become possible. This of course starts to create its own problems in the ability to handle data being read off at such rates.

It is an object of the invention to improve the handling of high data rates and when viewed from a first aspect the invention provides a data storage device comprising:
a data member comprising means for storing data on a surface thereof; and
a data retrieval member comprising:
   a plurality of heads for reading data from said data member; and
   a plurality of storage buffers each arranged to store data read from one of more of said heads;
      wherein said data retrieval member is arranged so as to output the contents of a plurality of said storage buffers sequentially.

Thus it will be seen by those skilled in the art that in accordance with the present invention data is read off the data retrieval member by the heads into local storage buffers. The data is output from each of these buffers into a queue so that data from each buffer arrives at the front of the queue in turn. This arrangement allows for a very high data transfer rate since all of the storage buffers can be filled during a single sweep of the data retrieval member over the data member and then sequentially output rather than outputting the data read by a single head at a time. Where, as is preferred in some embodiments, a storage buffer is associated with each head, this gives the possibility of reading out the entire data content of the data member in a single pass.

It should further be appreciated that since the local storage buffers provided in accordance with the invention represent a true reflection of the stored data there is no need for cache management—the buffers are simply transparent.

Further advantages obtainable in accordance with the invention are that it provides in simpler implementations the potential for a single processing entity to perform partial response mean likelihood (PRML) processing for example at the end of a row of heads. PRML is a well-know statistical technique for allowing greater storage densities by recovering data from very weak head signals.

A particular advantage of the local storage buffers in accordance with the invention is that data can be output from the data retrieval member whilst it is simultaneously reading new data from the data member but more importantly for facilitating the handling of large amounts of data, the data can be output from the data retrieval member even when it is not reading in new data. This is especially the case where, as is preferred, the data member and data retrieval are arranged to move in mutual oscillation since there is inevitably a ‘dead time’ in such arrangements twice in each cycle where the moving member(s) slows to a stop and reverses direction during which time data cannot be read from the data storage member. In accordance with the invention however the stored data can be, or continue to be, read out during this period. The local storage buffer thus allows the data transfer rate to be maximised by using all of the oscillation cycle rather than just those parts when data is actually being read in.

In accordance with the invention the storage buffers may simply store the basic pattern of flux changes measured by the heads for decoding—that is interpreting the pattern of flux changes as a string of 1's and 0's—after the sequential output. e.g. at the end of the row. This keeps construction of the data retrieval member simple. The storage could be analogue whereby an array of registers each stores an analogue value representing the flux at a particular point in much the same way as a charge-coupled device stores charges relating to light intensities in digital cameras and the like. Alternatively the flux signal could be digitally sampled with the buffer storing a digital representation of the flux signal. Analogue storage requires less storage capacity at the buffer. However the Applicants have appreciated that in some applications this might place a limit on the maximum areal density at which data can be stored on the data retrieval member and still be ultimately decoded accurately, since the buffer storage and transmission to the decoding processor will inevitably degrade the signal to a degree.

Digitally sampling the signal significantly reduces this problem so that relatively higher areal data storage densities on the data member could be supported. However it carries the disadvantage that the data storage requirement at the buffer is relatively high since for each flux change representing a bit of actual data stored, several bytes of signal sample data are likely to be needed.

In at least some preferred embodiments however the data retrieval member comprises means for decoding the signals read by the heads from the data member. This could be after the buffers but is preferably before the buffers. This is especially advantageous as it allows the true decoded digital data to be stored in the buffer and transferred off. Performing such processing at the head has the potential to reduce significantly the amount of data which needs to be stored in the buffers and/or transferred to a central processor. It also does not necessarily limit the areal data storage density which can be supported. Advantageously it allows local processing to be performed on the data read from the data member.

The decoding means may simply apply fixed thresholds to convert from the analogue flux signal to digital data. Preferably however it comprises means for processing the head signal to optimise the accuracy of conversion. For example the signal may be processed using PRML processing to improve the conversion of the weak analogue head signal to a digital signal.

Where, as is preferred, decoding means are provided as described above, the actual digital data stored on the data member is made available at the head. This data could simply be clocked out, in the manner of a shift register, in its entirety as explained earlier. Preferably though the data retrieval member further comprises local processing means associated with one or more heads for processing said digital data.

A particularly important application of arrangements in accordance with these preferred embodiments of the invention is in creating the potential for content addressable storage. This is a concept whereby rather than data being retrieved on the basis of its physical location on the data storage member (c.f. sector number on a traditional hard disk), retrieval is based on the actual content of the data. By communicating a predetermined criterion to the local buffers and equipping them with enough processing ability to be able to compare the data being read from the data member with such a criterion, it can be arranged that only data matching the criterion will be retrieved. This can significantly improve the speed with which the desired data is returned. This operation is to be contrasted with a situation whereby a large amount of data is retrieved from a storage medium but must be sifted through elsewhere, higher up in the architecture. Even though it may appear the latter involves large amounts of data being transferred from the storage medium, such high data rates are illusory as it is unsorted and so typically most of it will be useless.

In some preferred embodiments therefore the local processing means comprises comparison means arranged to store a predetermined criterion and to compare the data read from the data member with the predetermined criterion. The comparison means could be located before or after the data storage buffer or, preferably, be an integral part of it to allow the comparison processing of the data to be carried out while it is stored. This helps to minimise possible delays in transferring the required data. The comparison means could add a flag or other marker to data meeting the criterion. Alternatively one of a set of result strings could be written depending on the result of the match. Preferably however the result of the comparison is used to control the writing of data to the storage buffer. For example the comparison means may be arranged to write to the buffer if the predetermined criterion is met but not to write if it is not. This way only data which meets the criterion will be returned. In one set of preferred embodiments the predetermined criterion comparison comprises pattern matching. For example the data itself or an index therefor can be matched to one or more predetermined patterns. To give an example from a communications application, the criterion might be all data destined for a given Internet Protocol (IP) address. The IP address would them be loaded into the comparison means and only the relevant data returned. It will be appreciated that being able to perform basic data filtering such as this so close to the data storage is very powerful and has a significant positive effect on search response times and ‘true’ data rates.

Of course other criteria could be applied which need not be simple pattern matching. For example for data packets stored with a date identifier the criterion might be all data created in a given date range.

Pattern matching or other criteria comparison can apply equally to write functions too—for example only data with a predefined header is committed to the data member, the rest being discarded.

In a further set of preferred embodiments the local processing means is arranged to execute a set of instructions on the data. Such a set of instructions might, for example, alter the data before it is stored in the buffer, determine whether data is written at all, or write a result to the buffer in place of the data. The instructions could even cause data, altered data or a result to be written back to the data member.

The invention thus far described lends itself, in its various embodiments, to any conceivable way of organising data on the data member. It follows that any existing data organisation schemes can be employed directly or with simple adaptation. In many applications the data member will be most useful simply as a large homogenous data storage area. However the Applicants have also appreciated that in some embodiments it would be advantageous to divide the data member into discrete areas. This might be achieved purely logically—that is by means of an embedded controller. Alternatively there may be physical demarcations—e.g. so that data is read off from each area in sequence, in accordance with the invention, but data from different areas is handled separately. This might mean for example that data is not read off in whole rows/columns but in partial ones, the divisions depending upon the number of discrete areas on the data member.

One reason why it might be beneficial to divide a data member into discrete areas would be in order to replicate data across the respective areas. In other words each area effectively acts as an independent mini data member. This allows a single data member to replace redundant arrays of disks (e.g. RAID) that have to date commonly been specified for important data. A key point in this is that at least preferred embodiments of the present invention and the underlying technology disclosed in WO 2004/038701 enable scalability of data member size without sacrificing read or write speeds. It will of course be apparent that significant cost savings can be realised by scaling up a single data member rather than having to provide an array of disks and associated hardware.

In the simplest embodiments of the invention the storage buffers associated with each head are connected just to their neighbour so that data is always clocked off in one direction along the row of heads. The data retrieval member may be sub-divided so that each connected row extends only part-way across it. Preferably in such embodiments however all of the heads in a row extending across the data retrieval member are connected together so that the data is clocked off in whole rows. They may be connected so that the output of one buffer feeds directly into the input of the next so that each bit passes through the buffers in series until the edge of the member is reached. Alternatively there may be a common through-bus to which the buffer outputs are connected in turn. Either way an entire row of the data member can be read, and the data therefrom output, in a single pass. For example for a row of 512 heads, each of which has a sweep of 512 bytes of data in a whole row would represent 2097152 bits of data. With the data retrieval member oscillating at 715 passes per second (i.e. 357.5 Hz) the data read rate will be approximately 1.5 Gbps (gigabits per second). This matches the data rate currently supported by the Serial Advanced Technology Architecture (SATA) interface from Seagate Inc. for connecting hard disk drives to personal computers.

If data is output from the data retrieval member in rows, preferably there is an output data stream for each row on the data retrieval member. Typically the data for all of the rows is transferred to data handling means for performing a degree of processing thereof e.g. to decode the data if not already decoded or consolidate it into a single stream for passing onto the CPU.

However clocking off data in rows is not the only option in accordance with the invention. For example in accordance with some preferred embodiments rather than connecting heads only to their neighbours, which requires reading by rows, they may be connected to an interconnecting bus. This allows for example data from the heads in a given row to be read off in either direction—i.e. to either end of the row. Extending this, it is preferred in accordance with at least some embodiments for the heads also to be connected to columnar common interconnects to form a matrix allowing data to be read off in any direction. This arrangement would also allow for example data to be read off in rows whilst the columns are used for writing. The columns could also be used to communicate information to the heads, such as to mark rows of data as no longer required (i.e. effectively deleting the data by allowing overwrite) or to pass information to the heads e.g. relating to a predetermined criterion to be matched for local processing as described earlier.

Another possibility is that one of the directions could be used to manage writing of data. Since writing data requires much higher current and so generates much more heat than reading, it is envisaged that it may be necessary to restrict the frequency with which adjacent heads can write data to avoid local overheating. With rich connection possibilities this can be managed in a number of ways.

Moreover it is not necessary for the heads to be connected in a rectangular matrix. The buffers associated with one or more heads could be connected diagonally to form a diamond lattice; or both diagonally and orthogonally or any mixture of the two or anything inbetween. Indeed interconnections between the heads or their buffers need not be restricted to a single plane; there could be alternative interconnection paths on different levels. These levels could be built up on a single substrate or could be provided by one or more additional substrates—i.e. further very low expansion glass members on which connections are constructed. Indeed the data retrieval member might be fabricated without connections between the heads or their buffers, the connections being provided entirely by one or more connection members. This might allow the connection architecture to be customised to particular applications whilst using a common underlying data retrieval member.

It should be apparent from the foregoing that an individual head or storage buffer (which might have more than one head) can be connected to just one other or to a matrix node. If connected to a node the node may have any number of connections so with a corresponding number of possible paths that data output from the buffer can take.

One reason that the earlier described arrangements where data is clocked out in rows are simple is that the individual heads/buffers do not need to determine where the data goes; the data path is set by the connection architecture. However in accordance with the set of preferred embodiments described thereafter there is more than one possible path. Preferably therefore means associated with at least some of the storage buffers are provided for determining which of a plurality of potential data paths data output from the buffer will take. This adds to the electronics required at each head/buffer but makes the data storage device very powerful and flexible and gives rise to some very useful applications.

Although on an individual data path data is still output sequentially from buffers that are connected to that path and choose to output onto it, the greater variety of possibilities that arise with multiple data paths mean that data may well in certain applications come off less in a predetermined stream and more in a selective fashion. This applies particularly where some degree of local processing takes place e.g. to filter data so that only those which meet a predetermined criterion are read out. When viewed from another aspect therefore the invention provides a data storage device comprising a data member comprising means for storing data on a surface thereof; and a data retrieval member comprising: a plurality of heads for reading data from said data member; and a plurality of storage buffers each arranged to store data read from one or more of said heads, said buffers each being connected to a plurality of possible data output paths; wherein said data retrieval member comprises means associated with each of said buffers to determine which of said plurality of data paths the contents of said storage buffers will be output to.

Of course it should be appreciated that the reverse applies to data writing to the data member. In other words if each head/buffer is connected to a plurality of possible data paths on which read data can be output, it follows that data for writing can be received on one of a number of paths.

There are a large number of diverse possible applications for the architecture set out above. However the Applicants have realised that one area to which it can very beneficially apply is to the area of network data switching. With each head or buffer having the ability to receive data in one of a number of directions and output in another direction, the individual data paths can be seen as input/output ports and the head/buffer as a mini network node routing the data. Although in the examples given above each head swept over quite a small amount of stored data (e.g. 512 bytes), this is not limiting. Data storage devices in accordance with the invention set up for this sort of application may have a much smaller head density with each sweeping far more storage bits so that significantly more data can be queued at each ‘node’.

Where the Applicants see a particularly big opportunity for benefit is in applying the ideas above to switches in a telecommunications network. Before this is described in more detail, a little background will be given.

In recent years there has been significant development in the field of computer hardware and software which is used to provide switching functionality in packet-based telecommunications networks. Very simplistically in a packet-based switching network communications data—e.g. representing digitised speech—is divided into packets which include a destination address on the network. The packets of data are passed through the network by such switches which must route the packets as efficiently as possible to ensure that they do not spend too long reaching their destination. Clearly speech data is time critical and must be re-assembled into the correct order when it arrives. In order to maintain an acceptable level of intelligibility the packets must therefore be delayed as little as possible.

A telecoms switch will typically have a plurality of ports which can function as input or output ports. When a packet of data arrives on one of the ports it is the switch's job to allocate it to one of the output ports. This decision is made by the software controlling the switch based on factors such as the destination address and the existing length of queue at each port. Once allocated to a port, a particular packet is queued until it can be transmitted to the next node. The packets however have a lifetime which means that if a packet is left in a queue too long it will simply deleted—e.g. by marking the storage space it occupied for overwriting.

The Applicants have realised that the fact that existing switches commit packets to particular queues when they are received means that packet transit time cannot necessarily be optimised since the movement of queues is unpredictable, being influenced by external network conditions. However by implementing a telecoms switch using a data storage device in accordance with the embodiment of the invention set out above, packets do not need to be committed to a particular port when they come in since such a device allows data to be read out on more than one possible path which corresponds to outputting the data on more than one possible port. This is novel and inventive in its own right, for telecoms and more generally any communications and thus when viewed from a further aspect the invention provides a communications switch including a data storage device comprising a plurality of storage regions each connected to a plurality of possible data output paths; wherein said data storage device comprises means associated with each of said storage regions to determine which of said plurality of data paths data from that storage region will be output to. The data storage device is preferably in accordance with the other aspects of the invention. The data is preferably telecommunications data, e.g. voice data.

The invention also extends to a method of switching communications data comprising receiving an incoming data packet, storing said packets in one of a plurality of storage regions each connected to a plurality of possible data output paths; and determining which of said plurality of data paths data from that storage region will be output to. The data storage device is preferably in accordance with the other aspects of the invention. The data is preferably telecommunications data.

The invention also extends to a computer software product which when run on data processing means carries out the method set out above.

To give an example of this implementation each head might have all the desired output ports available to it so that incoming data can be written to the data member by any head and then output to the appropriate port. The port queues in such an implementation would be entirely logical—being stored on another part of the device or elsewhere. In other implementations certain subsets of heads, might be associated with certain subsets of output ports. Here, according to a preferred feature, incoming data packets are copied to more than one storage region so that each can be output on more ports than are associated with just one of the regions. When a particular packet is actually output on a port, e.g. because it has reached the front of a packet queue, the other copies of the packet in other storage regions can be deleted or marked for deletion.

The storage regions may be defined purely logically or partly or completely physically. Taking this further they could, in some embodiments, be provided by separate data retrieval members—e.g. those provided on a common substrate as described earlier. Indeed the separate storage regions could even be provided by completely separate data storage devices. Taken this far it would no longer be necessary for the individual data storage devices to be in accordance with the other aspects of the invention. They could instead be as described in WO 2004/038701. Alternatively they could be any other known form of data storage such as traditional hard disks. Thus when viewed from a further aspect the invention provides a communications data switching system comprising at least one input port for receiving packets of data and a plurality of output ports for data, each of said output ports having data storage means associated therewith for storing data packets queuing for transmission on that port, wherein said switching system is arranged to copy incoming data packets onto a plurality of said storage means and further arranged such that when a given data packet reaches the front of a queue, it is deleted or allocated for deletion from the other queues.

This invention also extends to a method of switching communications data comprising receiving packets of data on at least one input port, copying said packets of data to a plurality of data storage means associated with respective output ports in a such that said packets join queues of data packets awaiting transmission at each output port; and when a data packet reaches the front of a queue, deleting or allocating for deletion copies of said data packet in the other queues.

The invention also extends to a computer software product which when run on data processing means carries out the method set out above.

Thus it will be seen that in accordance with the arrangements set out above, rather than a data packet being committed on receipt to a queue for a single port, it is effectively not committed until it is actually ready to be sent out. This means that the allocation of packets may be kept dynamic thereby allowing the data packet to be transmitted from the first available port and so minimising the delay incurred.

The communication between the data storage device and a data handling means which passes data to and receive data from the device preferably comprises a plurality of data communication modules. These will typically match the connection pattern of the heads, so if the heads are connected so that data is read unidirectionally in rows, preferably one data communication module is provided for each row. It will be appreciated that two modules per row will be required if bi-directional clocking is allowed for; and column modules if columnar reading/writing is provided for. In general a module is required for each input/output port.

The data communication modules may take any convenient form—for example hard-wired connections, but preferably they comprise optical connections for superior bandwidth and reliability. Most preferably the data communication modules comprise edge lasers—that is to say there is a row of edge lasers transmitting data from the data retrieval member to optical fibres. For example if the data retrieval member has 512 rows and is clocked in the simplest manner, an array of 512 edge lasers in communication with 512 individual optical fibres would be needed.

Preferably the edge lasers are dynamically tuneable. This allows the data to be transmitted in the form of modulation of a broad spectrum of radiation. To give an example each spectrum could be encoded with 64 kilobytes of data. It will be appreciated that this is a similar principle to that which underlies the basic Dolby coding principle.

In accordance with at least some embodiments of the invention described thus far, data is read off the data retrieval member in rows or columns of individual heads, although some initial processing may be done locally at the individual head level. This opens the way to very low latency, high bandwidth mass data storage devices. However the inventors have appreciated that there are further possibilities for development of the ideas disclosed herein and in WO 2004/038701.

In accordance with a further set of preferred embodiments the data retrieval member comprises a processor in communication with a plurality of heads. Thus it will be seen that in accordance with this arrangement more sophisticated processing may be carried out than that which can be done on the data from one head since data from more than one head can be involved on the input and/or output sides of the processing carried out by the processor. The inventors have realised that the ability to read and write directly to/from a processor to permanent storage has a powerful advantage over the traditional computing model of a central processing unit with Random Access Memory (RAM) and a hard disk drive etc. It means that the processing/computing cycles and steps are recorded directly onto the mass storage medium, as opposed for example to storage in local RAM. This effectively gives a state-safe processor. Although this arrangement has the advantage that recovery e.g. from power interruption is very simple, more importantly it fundamentally changes the way that a computer including such a storage device operates since the data member essentially acts like a computing device both in the logical and physical structure. This means that data read and write speeds become less of a limiting factor since it is not necessary to transport data between a central processor and a slower data storage medium. The requirements for management of data flow and other ‘housekeeping’ are therefore correspondingly reduced.

In this arrangements described above the processors provided on the data retrieval member are different from conventional microprocessors in the way they are used. They are instead more like arithmetic units which use the buffers, and so the media member, as registers. In essence the data storage device itself is a processor.

Such arrangements are novel and inventive in their own right and thus when viewed from a further aspect the invention provides a data storage device comprising:
a data member comprising means for storing data on a surface thereof; and
a data retrieval member comprising:
   a plurality of heads for reading data from said data member; and
   a processor in communication with a plurality of said heads.

It will be appreciated that there are many possible ways in which this could be realised and the most appropriate will depend upon the most important characteristics for a particular application. To take one example there could be a single processor communicating with some or all the heads. It need not communicate with all of the heads as it may be decided to divide the capacity of the data storage into some associated with the processor and some which is used as more traditional mass storage—e.g. for a conventional processor off the device. However the single processor model makes clear the potential for a powerful state-safe processor.

Alternatively some or all the heads on the data retrieval member could be organised in clusters, each cluster having a common processor shared between the heads of that cluster. The clusters could be independent of one another, communicating only with further data handling and processing means off the data retrieval member. In at least some preferred embodiments however the clusters are at least to some extent interconnected. This could be through interconnection of the respective processors of the clusters. Again here there are many possibilities such as: each being connected to all the others; star or ring networks; other peer to peer networks; a bus layout; a tree hierarchy; or of course any combination of these. Additionally or alternatively the clusters could be interconnected through the heads. In other words some or all of the heads could communicate with more then one processor. This would, for example, give a degree of decoupling between the heads and buffers which would allow data to be written to the next cluster before that cluster is ready to receive it. This can be thought of as a state-safe register or buffer between the two clusters.

In general such clusters may replace heads in any of the topographies previously described, the internal structure of the cluster effectively being hidden from the other clusters/nodes etc.

In one set of preferred embodiments envisaged the clusters are interconnected in the manner of neurons—so that some are more richly connected than others. The connections need not be hard-wired—they could instead be virtual with clusters storing lists of their connections without the connections actually having to be made. Each cluster therefore preferably comprising means for storing a list of connections. More preferably said list comprises a count or value for each connection. This allows the data member and data retrieval effectively to act in a manner similar to a brain. This concept is very powerful in analysing and reporting on large volumes of data. Rather than, in the old model, having to search through large amounts of data looking for that meeting a specific list of criteria, the neuron model set out above essentially already has the relationships defined and so queries can be answered just by looking at the values associated with each connection (or each ordered pairing of nodes where the connection is virtual). Even with slow data access speeds therefore results can be obtained much quicker than in the conventional model as essentially the processing has already been done by the way the data is stored.

It would normally be the case that the connections and associated values are updated as more data is stored—i.e. the data storage structure learns.

Certain preferred embodiments of the invention will now be described, by way of example only, with reference to the accompanying drawings in which:

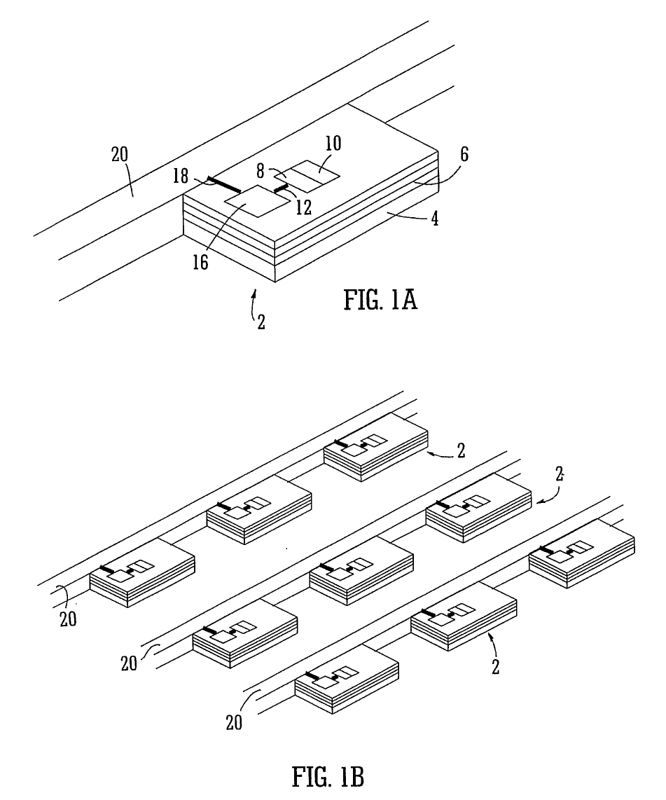

FIG. 1a is a physical representation of a read/write head assembly provided on a head member in accordance with the invention;

FIG. 1b is a representation of a small array of the heads of FIG. 1a connected together in rows;

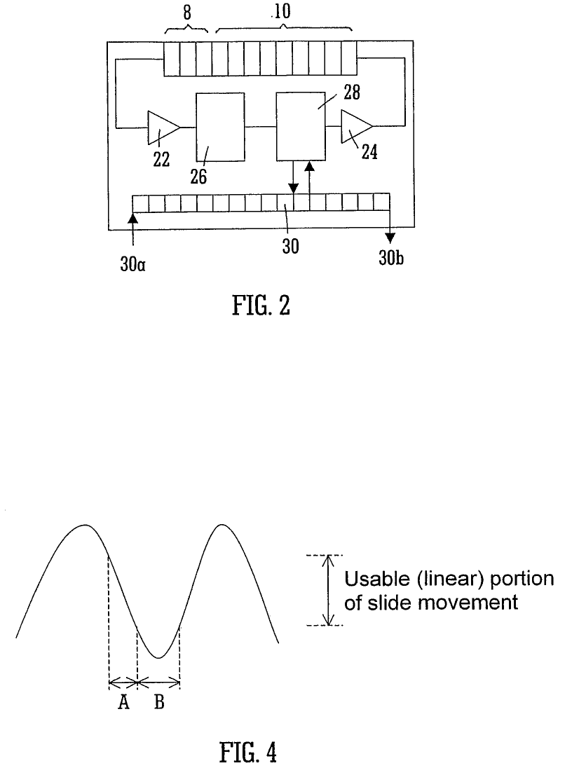

FIG. 2 is a schematic diagram of the functional components of the head assembly of FIG. 1;

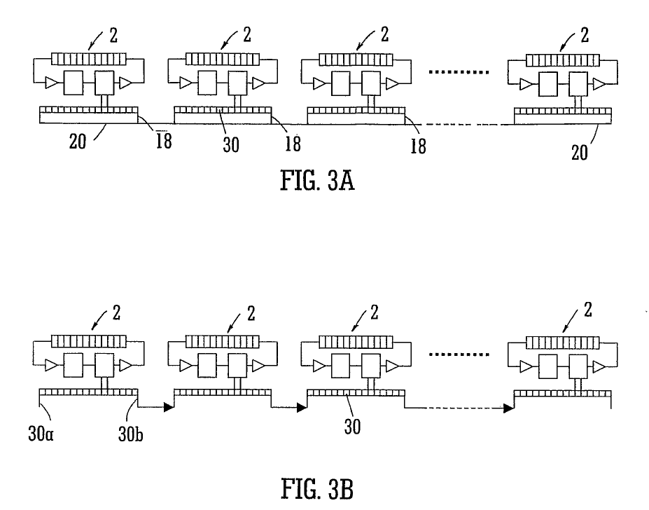

FIG. 3a is a schematic diagram of the head assemblies connected in a row corresponding to FIG. 1b;

FIG. 3b is a schematic diagram of another embodiment of the head assemblies connected in a row;

FIG. 4 is a plot of the motion of a data member indicating the extra useable portion in accordance with the invention;

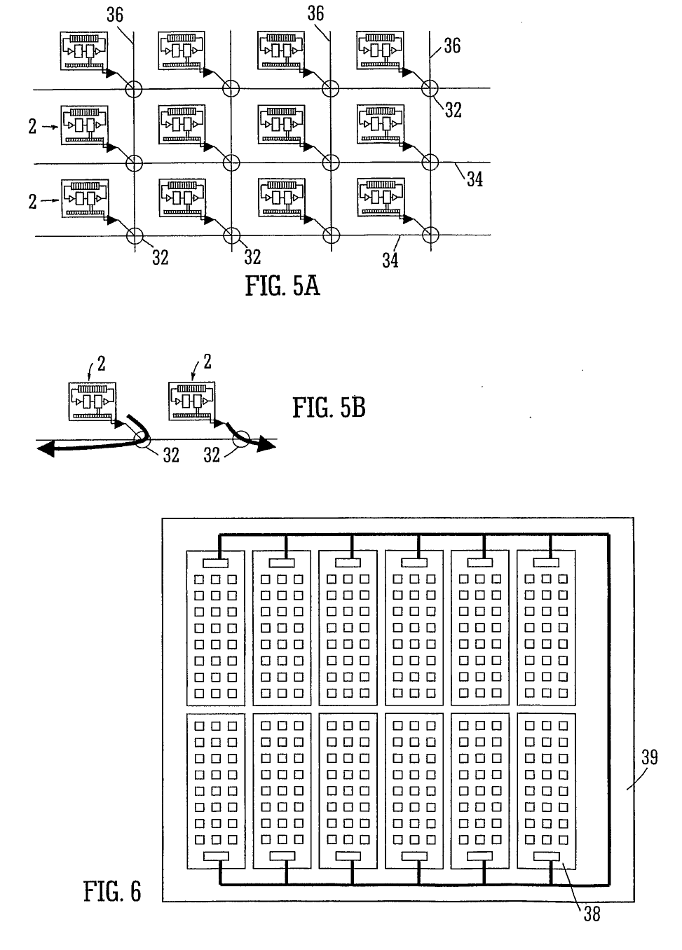

FIG. 5a is schematic diagram showing another way of interconnecting head assemblies;

FIG. 5b is a schematic representation of how data may be moved in the arrangement of FIG. 5a;

FIG. 6 is a schematic view of a data member subdivided into independent data areas;

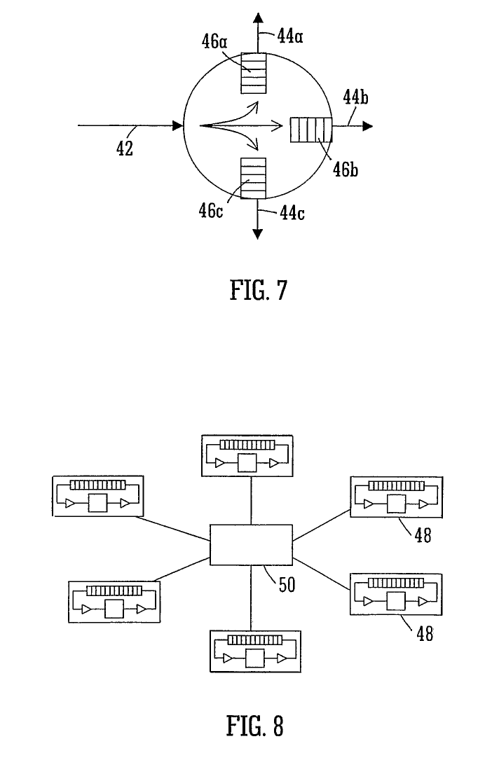

FIG. 7 is a schematic diagram representing the queuing of packet data in a telecoms switch;

FIG. 8 is schematic diagram of another embodiment showing the interconnection of head assemblies to a common processor;

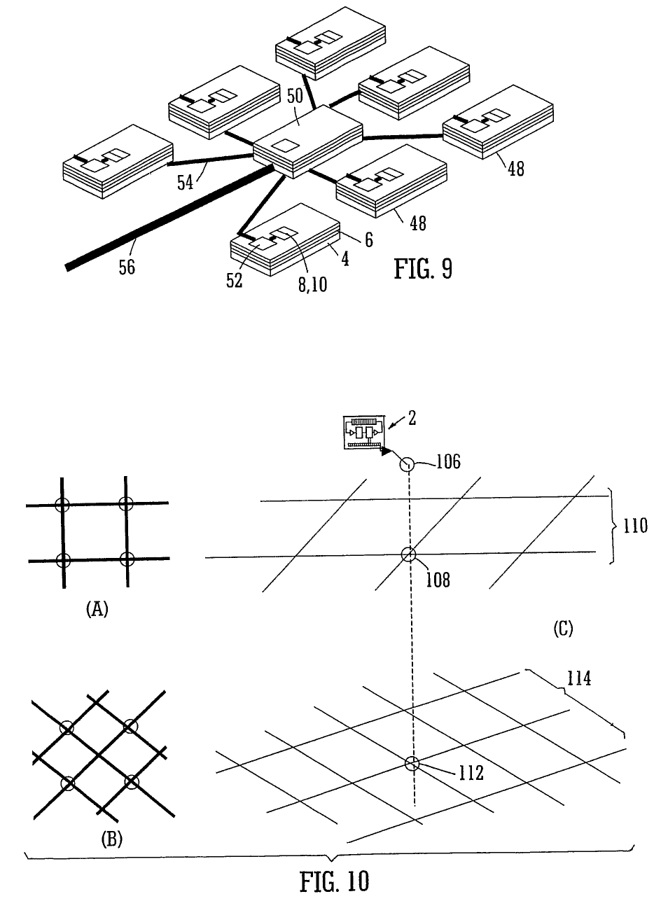

FIG. 9 is a physical representation of the embodiment of FIG. 8;

FIG. 10 shows schematically various possible interconnections between heads;

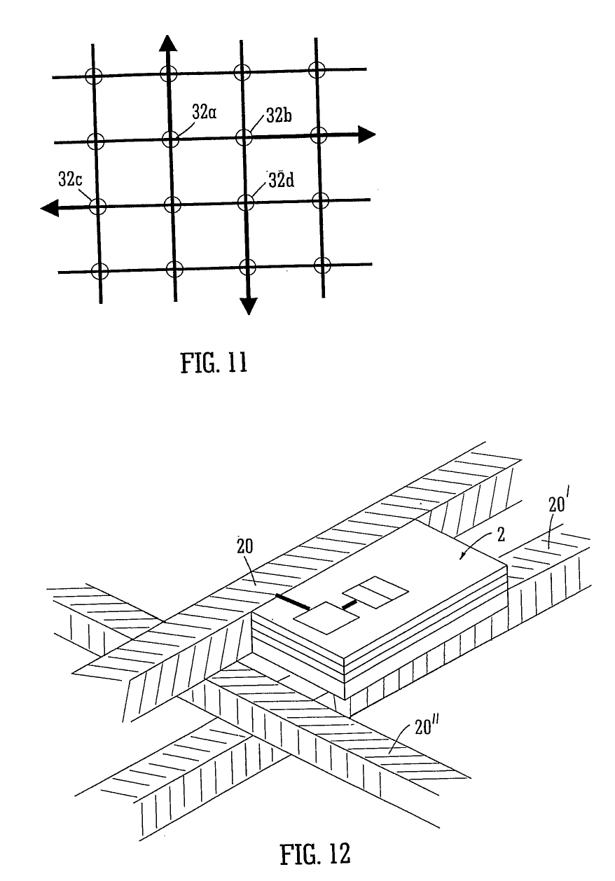

FIG. 11 shows the selective reading of data in different directions;

FIG. 12 shows a physical representation of a multiply connected head assembly;

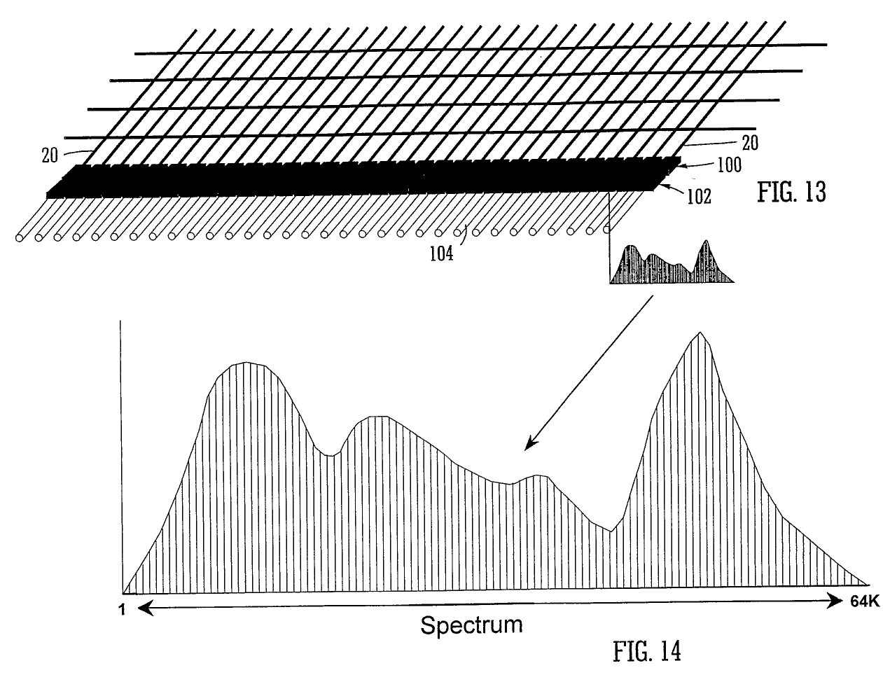

FIG. 13 shows schematically connection to the data storage device by edge lasers; and

FIG. 14 shows a representation of a modulated broad spectrum.

FIG. 1 shows a magnetic read/write head assembly 2 which is broadly similar to those described in WO 2004/038701 to which reference should be made for further details and possibilities. This will therefore be fabricated on a data retrieval member (hereinafter “head member”) comprising a very low expansion glass substrate. In use the head member is oscillated linearly with respect to an underlying corresponding magnetic data storage member (hereinafter “data member”) so that each head describes a sweep over a small strip of the data member.

The head assembly 2 is made up of a main polysilicon island 4 on which is stacked a series of deposition layers 6 of alternating copper and insulator. Defined within the deposition layers 6 by a suitable permalloy are a read head 8 and a write inductor 10. Again these are described in greater detail in WO 2004/038701. The read head 8 and write inductor 10 are connected by a copper interconnect to another region of the polysilicon island 4. Some electronic components 16 are built onto this part of the polysilicon island using standard lithographic mask techniques well known in integrated circuit fabrication. These are explained below with reference to FIG. 2. A further electrical interconnection 18 on one side of the electronics 16 connects the head assembly 2 to a larger copper connecting track 20. FIG. 1b shows a tiny fragment of a rectangular array of head assemblies 2 interconnected in rows by the copper connectors 20.

FIG. 2 is a schematic diagram of the components of the head assembly 2. They comprise the read head 8 and write head 10 connected respectively to a read pre-amplifier 22 and a write amplifier 24. At the output to of the read pre-amplifier is a pre-processor module 26 which applies a partial response maximum likelihood (PRML) algorithm to the flux change signal coming from the read head 8 to decode the signal into a series of 1's and 0's—i.e. to recover the data stored on the data member. This digital data stream is then passed to a post-processor module 28. The post-processor module 28 is loaded with a predefined pattern and is able to compare the data it receives with the pattern. The comparison is carried out using simple logic gates that set a flag to allow the data to be passed if the data matches the pattern. the data is passed on to be stored in a serial data buffer 30 which has an input end 30a and an output end 30b. Of course there may only be a match pattern defined under certain circumstances; the rest of the time the data can pass straight through. Equally the post-processor 28 may be omitted so that data always passes straight through. As may be seen from FIG. 3a the buffers 30 for each head assembly 2 are connected via interconnects 18 to a common communication bus 20. During each half oscillation of the data member, data is read from data member by the heads 8 and into the respective buffers 30 (subject to any pattern-matching conditions set). The data is then clocked out from each head in turn with the respective buffer connecting to the bus 20 while its data is output. Thus the buffer for the head closest head is connected first, followed by its neighbour and so on until each buffer in the row has been connected and output its data (if necessary). The bus 20 communicates the data to the edge of the head member from where it is communicated off the data member e.g. by a dynamically tuneable end laser as is shown in FIG. 13. Each data path 20 is connected at the edge of the head member to an optoelectronics module 100 which drives a corresponding dynamically tuned edge laser 102. An array of optical fibres 104 carries the data elsewhere e.g. to data handling means or an optical switch.

FIG. 14 shows the spectrum of light in a typical fibre 104. The data is used to modulate a broad spectrum so that each fibre has a bandwidth of 64 kilobytes. If there are 512 rows the bandwidth of the whole device is therefore 32 Mb.

Another embodiment is shown in FIG. 3a. In this embodiment the buffers for each head assembly 2 are connected serially in a row so that the output end of one buffer 30b is connected to the input end 30a of its downstream neighbour to form a single long shift register. Again during each half oscillation of the data member, data is read from data member by the heads 8 and into the respective buffers 30 (subject to any pattern-matching conditions set). The data is then clocked through the series of buffers to the edge of the head member from where it is communicated off the data member as previously described. The advantage of this embodiment over the earlier one is that it is much simpler to construct since no logic is required to control connection of the buffers to a communications bus. It is however less flexible as it only allows data to be read off in the pre-configured serial manner described.

FIG. 4 is a diagrammatic plot of displacement against time for the data member. It is driven by piezo-electric actuators (as described in WO 2004/038701) to execute approximately sinusoidal motion. The weakness of the signal induced in the read head 8 and the comparatively high level of noise mean that data can only reliably be read during when the motion of the data member is approximately linear as shown by the first region of the curve A. However since in accordance with the invention all heads on the head member can be read simultaneously and the data therefrom subsequently clocked out sequentially in rows/columns etc., this can be carried out during the portion of the cycle, indicated by B when the data member is slowing down, stopping and reversing direction. Previously this unused ‘dead’ time but now it can be fully utilised. As FIG. 4 shows, the ‘dead’ time B is a very significant portion of each half-cycle being about 50% longer than the ‘useful’ read time A.

It may be seen that the arrangement described above allows all heads on the data member to read data from the data member and for the data to be streamed off the head member in rows. At its limit this means that the entire data surface can be read in a single half-oscillation which is, as will be appreciated, extremely powerful.

FIGS. 5a and 5b show another embodiment of the invention where the head assemblies 2 are not connected together serially in rows but rather each is connected to an access node 32 in a matrix network of vertical and horizontal interconnects 34, 36. This clearly gives great flexibility in the direction in which data can be read in or out from each head assembly 2. Indeed it means that data may even pass in different directions along the same row as is illustrated in FIG. 5b, thereby effectively ‘breaking’ the row interconnection. It will be appreciated of course that to enable this functionality requires edge lasers or other means for transferring the data off the head member is required at both ends of each row and/or column.

The matrix and node structure shown in these Figures may be put to many different uses. To give one example data could be read off along the row interconnects 34 in much the same way as was described with reference to FIG. 3; data for writing to the media member could be passed along the column interconnects 36. Alternatively the column interconnects 36 could be used for passing search patterns to the post-processors 28 of each head assembly 2 to enable local data filtering.

Alternative connection structures are shown schematically in FIG. 10. The rectangular matrix of FIG. 5a is shown in FIG. 10(a). FIG. 10(b) shows an alternative diamond lattice connection structure. Here data will be read off the head member in parallel diagonal paths. FIG. 10(c) shows how a single head assembly 2 can be connected via an access node 106 to a node 108 in one matrix 110 say on the head member and also to a node 112 on a separate matrix 114 which could be on another glass substrate.

FIG. 11 shows diagrammatically how data can be read off from heads in a variety of directions. Thus the head at node 32a reads off to the top of the head member; the head at node 32b; reads off to the right; the head at node 32c reads left; and the last node 32d reads down.

FIG. 12 shows a physical representation of a head assembly 2 connected to a plurality of potential data paths 20, 20′ and 20″

FIG. 6 shows diagrammatically how a single head member surface—i.e. a single piece of glass—can be divided into a series of individual discrete head members 38 (ten being shown here for illustrative purposes). These could be physically cut up and used in separate drive units after surface fabrication is finished or, as shown, may be connected together and used with a common drive mechanism and data member. There are many applications where having multiple head members and therefore multiple data members is an advantage such as those in which redundant arrays of hard disks would previously have been used.

Another particularly beneficial application is described with reference to FIG. 7. This shows, highly schematically, a telecoms switch module 40 which is located at a node in a packet-switched telecommunications network such as voice over internet protocol (VoIP) network. In packet-switched networks two or more parties can conduct a voice call in which each party's speech is digitised and compressed and split up into a series of data packets which are then routed across a data network, with the packets in general following different paths through the network. At the recipient's end the packets are reconstructed in the correct sequence and converted back into audible speech. VoIP networks use the standard Internet Protocol for transporting the packets of speech data and therefore allow them to be transported over the public Internet. Packet-switched networks are becoming of increasingly greater interest for voice communications since they make more efficient use of bandwidth than more traditional circuit-switched voice networks where bandwidth is committed to a pair of parties for the duration of a call.

Returning to the node 40 shown in FIG. 7, this is shown schematically with a first port 42 on which a data packet is received and three possible output ports 44a, 44b, 44c which represent three different further nodes to which the switch can route the packet of data. Each output port has associated with it a portion of data storage 46a, 46b, 46c on which packets can be queued before being output to the network. In one embodiment these data storage portions are provided by respective individual data storage elements 38 on a common slide member as described with reference to FIG. 6, although they could instead by completely separate data storage devices or stored on a single homogenous device and divided only logically rather than physically. Indeed they could also each be the data storage region associated with single respective heads

When the data packet is received on the port 42 it is copied to all of the possible output port queues 46a, 46b, 46c. This could be all of the output port queues that the node 40 has or it could only be a subset of them—e.g. defined by the destination address of a particular packet or the queues at other nodes having reached a maximum length. The data packet will in general proceed up the queues 46a, 46b, 46c at different rates since these are determined by external network conditions and in particular those prevailing at the nodes to which the respective ports 44a, 44b, 46c connect. Once the packet reaches the front of the queue at one port, say third port 44c, the third port 44c then sends a message to the other two ports 44a, 44b instructing them to delete that packet from their queues 46b, 46c. This method allows data packets to traverse the node as efficiently as possible since they are not allocated to a particular output put until they are actually ready to be transmitted on. On the other hand however the provision of individual queues 46a, 46b, 46c for each port 44a, 44b, 44c means that no bottleneck is created which could reduce the rate at which the node 40 can receive packets as might be the case if a single central queue were provided. It also allows some allocation to be carried out as mentioned above on the basis of ports suitable for a particular destination and/or saturated ports.

In an alternative implementation where the storage regions are associated with respective individual heads it is not necessary to copy the packet to multiple heads since each head can output to each of the ports as explained with reference to FIGS. 5a, 5b, 10 and 11.

FIGS. 8 and 9 show respectively schematic and physical representations of another embodiment of the head member in which the individual heads 48 are arranged in clusters which share a common processor 50. As may be seen from FIG. 9, the physical layout of the heads 48 is similar to that described with reference to FIG. 1a with each being made up of a polysilicon island 4 and deposition layers 6 providing the read and write heads 8,10 and electronics 52. Here however the electronics differ. In particular the heads are not each provided with their own buffers as in previous embodiments; rather a single buffer is provided for the cluster which is incorporated within the common processor 50. Also each head 48 has only a single interconnect 54 to the common processor 50. The processor 50 has an interconnect 56 to a matrix access node (see FIG. 5a) although equally the clusters could be connected directly to each other. More generally where in earlier embodiments single head assemblies are shown, these could equally be replaced by a cluster of heads as shown in FIGS. 8 and 9. The cluster therefore acts logically like a single head and is addressed as a whole—its internal structure being opaque to the rest of the matrix.

The electronics 52 in the individual heads could include a decoder to convert the analogue flux signal to digital data or the signals could be decoded by the common processor 50. There is less penalty to carrying out decoding ‘remote’ from the read head in this arrangement than say decoding at the end of the row since the signal need only travel of the order of the separation of the head assemblies, that is of the order of hundreds of microns. The signal does not therefore degrade appreciably so that in turn this arrangement does not place an undue limit on the areal density of the data member.

The cluster topography described above allows more complex processing to be carried out involving data from more than one head. Moreover content addressing may be more complex, requiring an understanding of the data—e.g. network packets as the data may be spread across more than one head.

1. A data storage device comprising:
a data member arranged to store data on a surface thereof; and
a data retrieval member comprising:
a plurality of heads for reading data from said data member; and
a plurality of storage buffers each arranged to store data read from one
or more of said heads;
wherein said data retrieval member is arranged so as to output the contents of a plurality of said storage buffers sequentially.

2. A data storage device as claimed in claim 1 comprising a storage buffer associated with each head.

3. A data storage device as claimed in claim 1 wherein the data member and data retrieval are arranged to move in mutual oscillation.

4. A data storage device as claimed in claim 1 wherein the data retrieval member comprises signal decoder arranged to decode the signals read by the heads from the data member.

5. A data storage device as claimed in claim 4 wherein said signal decoder is arranged before the buffers.

6. A data storage device as claimed in claim 4 wherein said signal decoder is arranged to process the head signal.

7. A data storage device as claimed in claim 4, wherein the data retrieval member further comprises a local processing arrangement associated with one or more heads for processing said digital data.

8. A data storage device as claimed in claim 7 wherein said local processing arrangement comprises a comparison part arranged to store a predetermined criterion and to compare the data read from the data member with the predetermined criterion.

9. A data storage device as claimed in claim 8 wherein the comparison part is an integral part of the data storage buffer.

10. A data storage device as claimed in claim 8 wherein the comparison part is arranged such that the result of the comparison is used to control the writing of data to the storage buffer.

11. A data storage device as claimed in claim 8 wherein the comparison part is configured to test for a match to one or more predetermined patterns.

12. A data storage device as claimed in claim 7 wherein said local processing arrangement is arranged to execute a set of instructions on the data.

13. A data storage device as claimed in claim 1 comprising a plurality of discrete areas for storing data thereon.

14. A data storage device as claimed in claim 1 wherein the storage buffers associated with each head are connected just to their neighbours.

15. A data storage device as claimed in claim 1 wherein all of the heads in a row extending across the data retrieval member are connected together so that data can be clocked off in whole rows.

16. A data storage device as claimed in claim 14 comprising an output data stream for each row on the data retrieval member.

17. A data storage device as claimed in claim 1 wherein the storage buffers associated with each head are connected to an interconnecting bus.

18. A data storage device as claimed in claim 17 wherein the storage buffers associated with each head are connected to columnar common interconnects to form a matrix allowing data to be read off in any direction.

19. A data storage device as claimed in claim 17 wherein the storage buffers associated with each head have a plurality of connections such that data can be output from the respective buffers via a plurality of paths.

20. A data storage device as claimed in claim 19 comprising logic associated with at least some of the storage buffers to determine which of said plurality of potential data paths data output from the buffer will take.

21. A data storage device comprising:
a data member arranged to store data on a surface thereof; and
a data retrieval member comprising:
a plurality of heads for reading data from said data member; and a plurality of storage buffers each arranged to store data read from one or more of said heads, said buffers each being connected to a plurality of possible data output paths;
wherein said data retrieval member comprises logic associated with each of said buffers to determine which of said plurality of data paths the contents of said storage buffers will be output to.

22. A communications switch including a data storage device comprising a plurality of storage regions each connected to a plurality of possible data output paths; wherein said data storage device comprises logic associated with each of said storage regions to determine which of said plurality of data paths data from that storage region will be output to.

23. A communications switch wherein said data storage devices is as claimed in claim 1.

24. A method of switching communications data comprising receiving an incoming data packet, storing said packet in one of a plurality of storage regions each connected to a plurality of possible data output paths; and determining which of said plurality of data paths data from that storage region will be output to.

25. A computer software product which when run on a data processing arrangement carries out the method claimed in claim 24.

26. A telecommunications switch as claimed in claim 22 arranged to copy incoming data packets to more than one storage region so that each can be output on more ports than are associated with just one of the regions.

27. A communications data switching system comprising at least one input port for receiving packets of data and a plurality of output ports for data, each of said output ports having a data store associated therewith for storing data packets queuing for transmission on that port, wherein said switching system is arranged to copy incoming data packets onto a plurality of said stores and further arranged such that when a given data packet reaches the front of a queue, it is deleted or allocated for deletion from the other queues.

28. A method of switching communications data comprising receiving packets of data on at least one input port, copying said packets of data to a plurality of data stores associated with respective output ports such that said packets join queues of data packets awaiting transmission at each output port; and when a data packet reaches the front of a queue, deleting or allocating for deletion copies of said data packet in the other queues.

29. A computer software product which when run on a data processing arrangement carries out the method claimed in claim 28.

30. A communications data switching system as claimed in claim 27 further comprising:
a data member arranged to store data on a surface thereof, and
a data retrieval member comprising:
a plurality of heads for reading data from said data member, and
a plurality of storage buffers each arranged to store data read from one or more of said heads,
wherein said data retrieval member is arranged so as to output the contents of a plurality of said storage buffers sequentially.

31. A system as claimed in claim 27 comprising a plurality of data communication modules for communicating a data storage device with a data handling arrangement.

32. A system as claimed in claim 31 wherein said data storage device is arranged to read off data in rows and comprises at least one data communication module for each row.

33. A system as claimed in claim 31 wherein said data communication modules comprise optical connections.

34. A system as claimed in claim 31 wherein said data communication modules comprise edge lasers arranged to transmitting data from the data retrieval member to optical fibres.

35. A system as claimed in claim 34 wherein said edge lasers are dynamically tuneable.

36. A data storage device as claimed in claim 1 wherein said data retrieval member comprises a processor in communication with a plurality of heads.

37. A data storage device comprising:
a data member arranged to store data on a surface thereof; and
a data retrieval member comprising:
a plurality of heads for reading data from said data member; and
a processor in communication with a plurality of said heads.

38. A data storage device as claimed in claim 36 wherein some or all the heads on the data retrieval member could be organised in clusters, each cluster having a common processor shared between the heads of that cluster.

39. A data storage device as claimed in claim 38 wherein said clusters are at least to some extent interconnected.

40. A data storage device as claimed in claim 39 wherein respective clusters have differing numbers of connections.

41. A data storage device as claimed in claim 39 wherein each cluster is arranged to store a list of connections.

42. A data storage device as claimed in claim 41 wherein said list comprises a count or value for each connection.

43. A communications data switching system as claimed in claim 27 further comprising:
a data member arranged to store data on a surface thereof, and
a data retrieval member comprising:
a plurality of heads for reading data from said data member; and
a plurality of storage buffers each arranged to store data read from one or more of said heads, said buffers each being connected to a plurality of possible data output paths,
wherein said data retrieval member comprises logic associated with each of said buffers to determine which of said plurality of data paths the contents of said storage buffers will be output to.
